(19) United States
(12) Patent Application Publication
(10) Pub. No.: US 2025/0208819 A1
(43) Pub. Date: Jun. 26, 2025

(54) Content Transfer

(71) Applicant: APPLE INC., Cupertino, CA (US)

(72) Inventors: Ivan S. Maric, Palo Alto, CA (US); Jan K. Quijalvo, San Jose, CA (US)

(21) Appl. No.: 18/851,374

(22) PCT Filed: Apr. 24, 2023
(86) PCT No.: PCT/US2023/019631

§ 371 Date: Sep. 26, 2024

Related U.S. Application Data
(60) Provisional application No. 63/334,448, filed on Apr. 25, 2022.

(51) Int. Cl. G06F 3/14; G06F 3/01

(52) U.S. Cl. CPC G06F 3/1454; G06F 3/017

(57) ABSTRACT

A wearable device configured to present first content to a user in combination with a view of an environment, and an external device is configured to present second content to the user. A controller associated with at least one of the wearable device or the external device is configured to detect an intention to transfer display of a content item between the wearable device and the external device, and to transfer display of the content item in response to detecting the intention.

### CROSS-REFERENCE TO RELATED APPLICATIONS

This application claims the benefit of U.S. Provisional Application No. 63/334,448, filed on Apr. 25, 2022, the content of which is hereby incorporated herein by reference in its entirety for all purposes.

### FIELD

The present disclosure relates generally to the field of information transfer between computing devices.

### BACKGROUND

Computing devices allow for presentation of various types of content. Information can be transmitted between devices using wired and wireless communications protocols.

### SUMMARY

One aspect of the disclosure is a wearable device that includes a display device configured to present first content in combination with a view of an environment, and a controller. The controller is configured to detect an intention to transfer display of a content item between the display device and an external device that is configured to present second content, and transfer display of the content item in response to detection of the intention.

The controller may be further configured to detect a gesture, wherein the intention to transfer display of the content item is detected based on the gesture. The controller may be further configured to determine that the gesture indicates a selection of the external device based on a comparison of a view angle of the wearable device to a location of the external device. The controller may be further configured to determine a motion direction associated with the gesture, and determine that the gesture indicates a selection of the external device based on a comparison of the motion direction to a location of the external device. The controller may be further configured to determine a motion direction associated with the gesture, and determine a destination display position for the content item based on the motion direction, wherein the controller transfers display of the content item according to the destination display position. The gesture may include a transfer initiation sub-gesture, a positioning sub-gesture, and a transfer completion sub-gesture, and the controller is further configured to determine a destination display position for the content item on at least one of the wearable device or the external device based on the positioning sub-gesture.

The intention to transfer display of the content item may be detected based on a determination that the wearable device is at a location associated with the external device. The controller may be further configured to output a notification regarding transfer of display of the content item to a user in response to the determination that the wearable device is at the location associated with the external device, wherein the intention to transfer the content item is detected further based on receiving a confirmation input from the user in response to the notification.

The intention to transfer display of the content item may be detected based on a determination that a view angle of the wearable device corresponds to a location of the external device. The controller may be further configured to output a notification regarding transfer of display of the content item to a user in response to the determination that the view angle of the wearable device corresponds to the location of the external device, wherein the intention to transfer the content item is detected further based on receiving a confirmation input from the user in response to the notification.

Another aspect of the disclosure is a device that includes a display device configured to present first content to a user; and a controller. The controller is configured to detect an intention to transfer display of a content item between the display device and a wearable device that is configured to present second content to the user in combination with a view of an environment, and transfer display of the content item in response to detection of the intention.

Another aspect of the disclosure is a system that includes a wearable device configured to present first content to a user in combination with a view of an environment, an external device configured to present second content to the user, and a controller associated with at least one of the wearable device or the external device. The controller is configured to detect an intention to transfer display of a content item between the wearable device and the external device, and transfer display of the content item in response to detection of the intention.

Another aspect of the disclosure is a system that includes a wearable device configured to present first content to a user in combination with a view of an environment and an external device configured to present second content to the user. A controller associated with at least one of the wearable device or the external device is configured to detect a gesture that indicates an intention to transfer display of a content item between the wearable device and the external device, and transfer display of the content item in response to detection of the gesture.

The gesture may be made by the user while the external device is visible in the view of the environment presented to the user by the wearable device. The controller may be further configured to determine that the gesture indicates a selection of the external device based on a comparison of a view angle of the wearable device to a location of the external device. The controller may be further configured to determine a motion direction associated with the gesture, and determine that the gesture indicates a selection of the external device based on a comparison of the motion direction to a location of the external device. The controller may be further configured to determine a destination display position for the content item based on the motion direction, wherein the controller transfers display of the content item according to the destination display position. The gesture may include a transfer initiation sub-gesture, a positioning sub-gesture, and a transfer completion sub-gesture, and the controller may be further configured to determine a destination display position for the content item on at least one of the wearable device or the external device based on the positioning sub-gesture.

The controller may be further configured to determine that the gesture was made by a third party user, and determine that the third party user is authorized by the user to transfer display of the content item. The gesture may be detected using a sensor output from at least one of a first sensor associated with the wearable device or a second sensor associated with the external device. The gesture may be detected using a combined sensor output that includes information from a first sensor associated with the wearable device and information from a second sensor associated with the external device. The controller may be further configured to terminate execution of a first computing process associated with display of the content item at one of the wearable device or the external device, and start execution of a second computing process associated with display of the content item at the other one of the wearable device or the external device.

Another aspect of the disclosure is a system that includes a wearable device, an external device, and a controller associated with the wearable device. The controller is configured to cause the wearable device to display a content item in combination with a view of an environment, output an indication of intention to transfer the content item based on a determination that the wearable device is at a location associated with the external device, and transfer display of the content item from the wearable device to the external device in response to the indication of intention to transfer the content item.

The controller may be further configured to output a notification regarding transfer of display of the content item to a user in response to the determination that the wearable device is at the location associated with the external device, wherein the indication of intention to transfer the content item is output upon receiving a confirmation input from the user in response to the notification. The controller may be further configured to transfer display of the content item automatically in response to the indication of intention to transfer the content item. The location associated with the external device may be a predefined area. The location associated with the external device may be defined by a threshold distance around the external device.

Another aspect of the disclosure is a system that includes a wearable device configured to present first content to a user in combination with a view of an environment, an external device configured to present second content to the user, and a controller associated with the wearable device. The controller is configured to cause the wearable device to display a content item as part of the first content, output an indication of intention to transfer the content item based on a determination that a view angle of the wearable device corresponds to a location of the external device, and transfer display of the content item from the wearable device to the external device for display by the external device as part of the second content in response to the indication of intention to transfer the content item.

The controller may be further configured to output a notification regarding transfer of display of the content item in response to the determination that the view angle of the wearable device corresponds to the location of the external device, wherein the indication of intention to transfer the content item is output upon receiving a confirmation input from the user in response to the notification. The controller may be further configured to transfer display of the content item automatically in response to the indication of intention to transfer the content item. The controller may be further configured to determine the location of the external device using a sensor output from a sensor associated with the wearable device. The controller may be further configured to determine the location of the external device using signals that are received by the wearable device from the external device using a wireless communications connection.

### BRIEF DESCRIPTION OF THE DRAWINGS

FIG. 1 is a schematic illustration of a system.

FIGS. 2A-2B are schematic illustrations of content transfer according to a first example.

FIG. 3 is a flowchart of a process for content transfer.

FIGS. 4A-4B are schematic illustrations of content transfer according to a second example.

FIGS. 5A-5B are schematic illustrations of content transfer according to a third example.

FIGS. 6A-6D are schematic illustrations of content transfer according to a third example.

FIG. 7 is a schematic illustration of content transfer according to a fifth example.

FIG. 8 is a block diagram of an example of a hardware configuration for a device.

### DETAILED DESCRIPTION

The disclosure herein relates to transferring content between a wearable computer-generated reality (CGR) device and an external device. As used herein, the term “content” broadly encompasses any manner of experience or information that can be presented to a user by a device, and includes, for example, presentation of content that is generated by an application, presentation of a video, presentation of images, playback of audio, and display of text.

Some wearable computer-generated reality devices display content in combination with a view of an environment around the device (e.g., a physical environment as opposed to a virtual environment). Examples include optical passthrough and video passthrough augmented reality devices. Optical passthrough devices display information on a translucent (which as used herein is inclusive of transparent) structure, through which the user may view the environment. Video passthrough devices display information on a display screen by overlaying the content on a visual representation of the environment. The visual representation may be or include video of the environment that is captured contemporaneously. In both optical passthrough and video passthrough devices, the content may or may not be displayed in spatial correspondence with features of the environment.

While using the wearable CGR device, the user may be located near an external device that is also able to display content. Examples include a display screen and a translucent display system, such as a heads up display. The systems and methods described herein allow the user to transfer content items between the devices. In one example, the user is listening to audio when they enter a space, and a user interface that controls audio playback is displayed by the wearable CGR device. Either automatically, or upon an explicit expression of intention by the user, playback of the audio content and/or display of the user interface may be transferred to the external device. This may be useful, for example, to allow the user to leverage additional capabilities of the external device that are not possessed by the wearable CGR device, or to share content with other persons who are present near the external device. Implementations of these systems and methods will be described in further detail herein with reference to specific implementations.

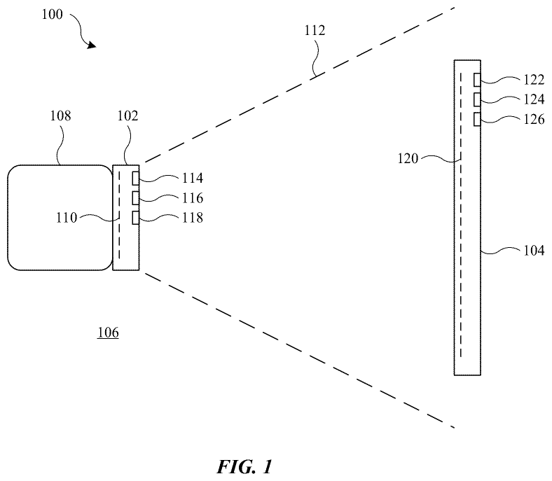

FIG. 1 is a schematic illustration of a system 100 that allows content to be transferred between a wearable device 102 and an external device 104. The wearable device 102 and the external device 104 are located near one another in an environment 106, which may be referred to as a physical environment or a surrounding environment. The wearable device 102 is configured to present content to a user 108 (e.g., who wears the wearable device 102) in combination with a view of the environment 106 using a first display 110 (e.g., a first display device or a wearable device display). A field of view 112 of the wearable device 102 represents the spatial extent of the view of the environment 106 that is presented to the user 108 in combination with content that is displayed by the wearable device 102.

The wearable device 102 is a CGR device that combines the content with the view of the environment 106. As one example, the wearable device 102 may combine the content with the view of the environment 106 using an optical combiner that displays the content in combination with the first display 110 of the wearable device 102 in an optical passthrough arrangement. In another implementation, the wearable device 102 may combine the content with the view of the environment 106 by capturing video of the environment 106 and defining a composite image that includes the view of the environment 106 and the content, and presenting the composite image to the user 108 using the first display 110 of the wearable device 102.

The wearable device 102 includes sensors 114, such as imaging devices (e.g., visible and/or infrared spectrum video cameras) and three-dimensional sensing devices (e.g., lidar, radar, ultrasonic, depth cameras, and structured light devices). The sensors 114 may be used, for example, to obtain images of the environment 106 for display or for use by functions of the wearable device 102 such as position tracking for the wearable device 102, view angle tracking for the wearable device 102, gaze angle tracking (e.g., by analysis of images of the eyes of the user 108), or gesture recognition. The sensors 114 may also include motion tracking sensors such as an inertial measurement unit (e.g., including accelerometers, gyroscopes, and/or magnetometers). The sensors 114 may also include user-operated input devices, such as, for example, a controller that is held in the hand or the user 108, a controller that is worn on a wrist of the user 108, or a controller that is worn on a finger of the user 108. The wearable device 102 includes a communications device 116 that allows for wireless transmission and receipt of signals and/or data using wireless networking and/or direct communications with other devices using any suitable wireless communications protocol. The wearable device 102 includes a controller 118, which is a computing device that is configured to implement functions of the wearable device 102, such as position tracking, hand tracking, gesture recognition, rendering of content, and display of content. These functions may be implemented using computer program instructions that are available to the controller 118 and, when executed, cause execution of computing processes associated with the functions.

The external device 104 is configured to present content to the user 108 using a second display 120 (e.g., a second display device or an external device display). The second display 120 of the external device 104 may be, as examples, a display screen or a heads up display. The external device 104 includes sensors 122 that are equivalent to the sensors 114 of the wearable device 102. The external device 104 includes a communications device 124 that is equivalent to the communications device 116 of the wearable device 102. The external device 104 also includes a controller 126, which is a computing device that is equivalent to the controller 118 and is configured to implement functions of the external device 104, such as display of content.

The external device 104 is located near the wearable device 102 when content is transferred between the wearable device 102 and the external device 104. In the illustrated example, the external device 104 is located within the field of view 112 of the wearable device 102 at when content is transferred between the wearable device 102 and the external device 104. Location of the external device 104 within the field of view 112 of the wearable device 102 during transfer of content allows the user 108 to view the content presented by the external device 104 both before and after the transfer of the content. Location of the external device 104 within the field of view 112 of the wearable device 102 may also be used a signal that controls an aspect of the transfer of the content, such as by selecting the external device 104 as a source or destination for the transfer or by guiding positioning of the content on the first display 110 of the wearable device 102 or on the second display 120 of the external device 104.

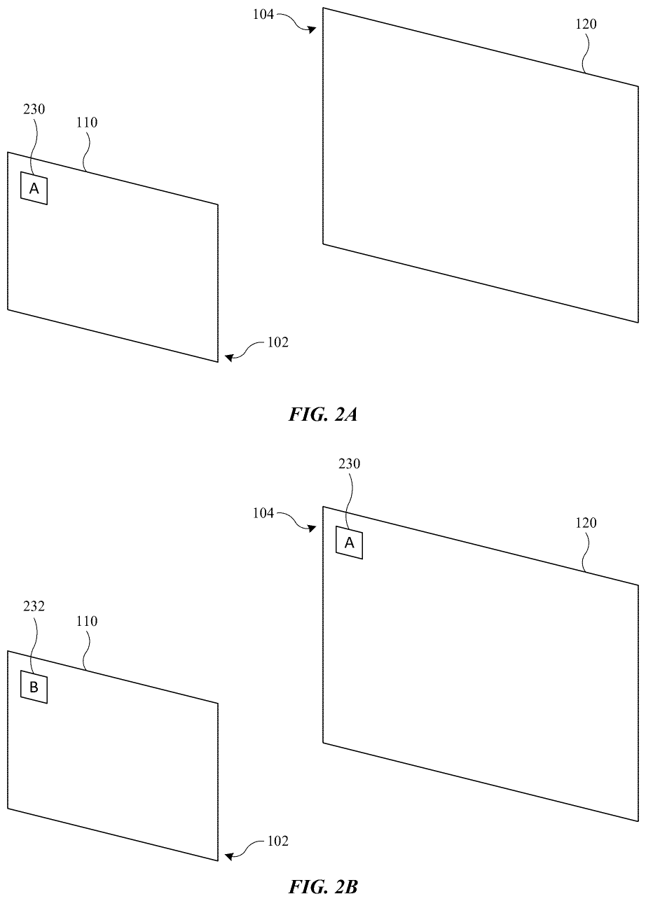

FIGS. 2A-2B are schematic illustrations of content transfer according to a first example. FIG. 2A shows the first display 110 of the wearable device 102 and the second display 120 of the external device 104 before transfer of a content item 230 from the wearable device 102 to the external device 104. FIG. 2B shows the first display 110 and the second display 120 after transfer of the content item 230 from the wearable device 102 to the external device 104. It should be understood that the example described with respect to FIGS. 2A-2B includes transfer of the content item 230 from the wearable device 102 to the external device 104, but is applicable more generally to transfer of the content item 230 and/or other content between the wearable device 102 and the external device 104, inclusive of transfer of the content item 230 from the external device 104 to the wearable device 102, which may be implemented in the same manner.

The content item 230 includes graphical content, such as images, video, and/or a user interface that, for example, presents information about the content or provides user interface elements that allow the user to control or interact with the content item 230. The content item 230 may also include audio content that is accompanied by a graphical user interface. The content item 230 may occupy a limited area of the display device on which it is presented, such as the first display 110 or the second display 120, and may be displayed at a particular position relative to the spatial extents of the first display 110 or the second display 120, such as along a side (e.g., left, right, top, or bottom) or in a corner. The content item 230 may be one of multiple content items and/or other visual elements that are presented to the user 108 on the first display 110 of the wearable device 102 or the second display 120 of the external device 104.

Prior transfer of the content item 230, as shown in FIG. 2A, the wearable device 102 presents content to the user 108, including the content item 230, which is presented in combination with a view of the environment 106. Subsequent to transfer of the content item 230, the content item 230 is presented to the user 108 on the second display 120 of the external device 104, optionally in combination with other content. The content item 230 is removed from the first display 110 upon transfer of the content item 230 to the second display 120. Optionally, a supplemental content item 232 may be displayed on the wearable device 102 after the transfer, where the supplemental content item 232 is related to the content item 230 (e.g., the content item 230 and the content item 232 may be generated by the same application). As one example, if the content item 230 is a video, the supplemental content item 232 may be a name of the video and/or other bibliographic information. As another example, if the content item 230 is a map showing a route, the supplemental content item 232 may indicate a navigation instruction (e.g., “turn left”). As another example, if the content item 230 is a presentation that is being displayed to other persons, the supplemental content item 232 may be speaker's notes.

Transfer of the content item 230 between the wearable device 102 and the external device 104 is facilitated by a wireless communications connection that is established between the communications device 116 of the wearable device 102 and the communications device 124 of the external device 104 to allow for electronic communications (e.g., transmission and receipt of signals and/or data) between them. The wireless communications connection can be established at the time when the content transfer is initiated, or can be established prior to a command or other circumstance that causes the content transfer to be initiated. Establishing the wireless communications connection may be performed by a pairing process, which may include, as examples, one or more of manual selection of the external device 104 by the user 108, automatic pairing based on proximity, pairing in response to presence of the external device 104 within the field of view 112 of the wearable device 102, pairing in response to determining that a gaze angle of the user 108 is directed toward the external device 104, or pairing in response to detection of a visual pairing code (e.g., a QR code) associated with the external device 104 by the sensors 114 (e.g., visible spectrum cameras) of the wearable device 102.

In some implementations of pairing the wearable device 102 and the external device 104, one or both of the controller 118 of the wearable device 102 or the controller 126 of the external device 104 are configured to determine co-presence of the wearable device 102 and the external device 104 based on wireless communications signals emitted by at least one of the wearable device and the external device, and determine the location of the external device 104 with respect to the wearable device 102 in response to the determination of co-presence of the wearable device 102 and the external device 104. As one example, upon receiving signals indicating that the external device 104 is located in the environment 106 near the wearable device 102, the wearable device 102 may determine the location of the external device 104 relative to the wearable device 102 by analyzing images and/or three-dimensional scans obtained by the sensors 114 of the wearable device 102. As another example, the wearable device 102 may receive signals that are transmitted by the external device 104 that are interpretable to determine the location of the external device 104 relative to the wearable device 102, such as a relative distance and/or a relative angular position of the external device 104 relative to the wearable device 102.

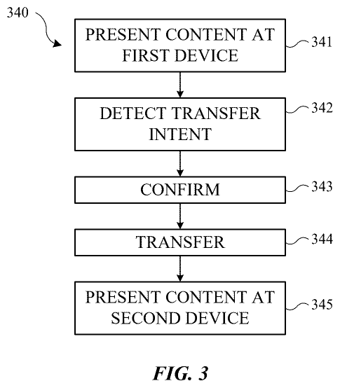

FIG. 3 is a block diagram that shows a content transfer process 340 according to an example. The content transfer process 340 may be implemented, for example, in the form of a system that includes one or processor, a memory, and or computer program instructions that are stored in the memory device and are executable by the one or more processors to cause the processors to perform operations that correspond to the content transfer process 340. The content transfer process 340 may be implemented, for example, in the form of a non-transitory computer-readable storage device containing computer program instructions that, when executed by one or more processors, cause the one or more processors to perform operations that correspond to the content transfer process 340. Other implementations are possible.

In the illustrated example, the content transfer process 340 includes displaying content at a first device in operation 341, detecting an intention to transfer display of content from the first device to a second device in operation 342, requesting confirmation of the intention to transfer the display of the content in operation 343, which is optional, transferring the display of the content from the first device to the second device in operation 344, and displaying the content at the second device in operation 345. The content transfer process 340 can be implemented using the system 100, for example, to transfer the content item 230 between the wearable device 102 and the external device 104, and will be explained using the system 100 as an example. In implementations using the system 100, operations of the content transfer process 340 may be performed by either or both of the controller 118 of the wearable device 102 and the controller 126 of the external device 104. Similarly, sensor inputs used in the content transfer process 340 may be obtained by either or both of the sensors 114 of the wearable device 102 and the sensors 122 of the external device 104.

At the time of the content transfer that is implemented by the content transfer process 340, the wearable device 102 is located near the external device 104. As one example, the external device 104 may be within visual range of the wearable device 102, independent of a current view direction of the wearable device 102. In another example, the external device 104 or may be within the field of view 112 of the wearable device 102. As will be explained herein, the location of the external device 104 with respect to the wearable device 102 and/or with respect to a view direction of the wearable device 102 may be used as an input, based on which a determination is made, during the content transfer process 340.

In operation 341, the content item 230 is displayed by the wearable device 102 using the first display 110 in combination with a view of the environment 106. As examples, the content item 230 may be viewed on a transparent display structure that allows a direct view of the environment 106 in combination with the display structure, or the content item 230 may be viewed as part of a composite image that combines the content item 230 and video representing the environment 106, which may be obtained contemporaneously.

Operation 342 includes detecting an intention to transfer the content item 230 from the wearable device 102 to the external device 104. The content transfer may be initiated in response to detection of the intention to transfer display of the content item 230.

Operation 342 may include outputting an indication of the intention to transfer the content item based on detecting the intention to transfer the content item. The indication is a signal (e.g., a value, a variable, a message, etc.) that can be used to trigger other operations, such as transferring display of the content item 230 in operation 344. Outputting the indication of intention to transfer the content item may additionally be performed based on one or more additional steps, such as receiving a confirmation input from the user as will be described with respect to operation 343.

Information indicative of intention to transfer the content item 230 may take multiple forms that can be detected using the sensors 114 of the wearable device 102 and/or using the sensors 122 of the wearable device 104. The intention that is detected in operation 342 may be an explicit user command that is intended by the user 108 to initiate the content transfer. Examples of an explicit user command include a verbal command, a gesture command, and operation of the physical button, for example, located on a handheld controller, a finger-worn controller, or a wrist-worn controller. The intention that is detected in operation 342 may also be implicit or predicted, for example, based on a location of the external device 104, a view angle of the external device 104, or a gaze angle of the user 108, as determined by eye tracking using the sensors 114 of the wearable device 102.

As one example of detection of intention to transfer the content item 230 in operation 342, the user 108 may utter a verbal command that requests transfer of the content item 230. The verbal command may identify the content item 230 (e.g., by a name of the specific content item, the application, or the type of content) and may identify the destination (e.g., by a pre-selected name for the device or by a device type). Examples of such a command may include utterance, by the user 108 of a phrase such as “transfer the weather app to my smartphone,” or “display this video on that television,” where the term “that television” is interpreted by the controller 118 of the wearable device 102 and/or the controller 126 of the external device 104 as designating a television that is in the field of view 112 of the wearable device 102 as the external device 104 that the content item 230 is to be transferred to. Thus, a verbal command may stand alone as an expression of intention, by the user 108, to transfer the content item 230 and a selection of the destination of the transfer, or the verbal command may be combined with another condition, such as the view angle of the wearable device 102 or the gaze angle of the user 108, to define the expression of intention, by the user 108, to transfer the content item 230 and a selection of the destination of the transfer.

As another example of detection of intention to transfer the content item 230 in operation 342, the user 108, the location of the external device 104 is determined (e.g., by the wearable device 102 using the sensors 114), and the controller 118 is configured to determine that a view angle of the wearable device 102 corresponds to the location of the external device 104, which is considered to be an expression of intent in this implementation. As an example, the view angle can be determined to correspond to the location of the external device 104 when the view angle is directed toward the external device 104, or when the view angle has been directed toward the external device 104 for longer than a threshold time period (e.g., three seconds). In response, the controller 118 of the wearable device 102 is configured to initiate a transfer of display of the content item 230 from the wearable device 102 to the external device 104. This may be automatic or subject to confirmation as will be described with respect to operation 343. For example, the controller 118 of the wearable device 102 may be configured to initiate the transfer of display of the content item 230 by outputting a notification regarding the transfer of display of the content item 230 and causing the transfer of display of the content item 230 upon receiving a confirmation input from the user 108 in response to the notification. As another example, the controller 118 of the wearable device 102 may be configured to initiate the transfer of display of the content item 230 by automatically causing the transfer of display of the content item 230 in response to the determination that the view angle of the wearable device 102 corresponds to the location of the external device 104.

As another example of detection of intention to transfer the content item 230 in operation 342, the user 108 may make a gesture command, for example, using their hands, that expresses the intention to transfer the content item 230. The gesture is made by the user 108 while the user is near the external device 104, as proximity of the wearable device 102 to the external device 104 is associated with an intention to transfer content between them. As an example, the gesture may be made by the user while the external device 104 is visible in the view of the environment 106 that is presented to the user 108 by the wearable device 102, which serves as a further indication of an intention to transfer content between them.

The gesture may stand alone as an expression of intention or may be combined with another signal (e.g., observed by the sensors 114) to determine intention. As one example, wearable device 102 may be configured to determine that the gesture indicates a selection of the external device 104 when the gesture occurs while the view angle corresponds to the location of the external device 104, based on a comparison of a view angle of the wearable device 102 to the location of the external device 104.

The gesture command is made by the user 108 by physical motion and is detected using sensor outputs from sensors 114 of the wearable device 102 and/or using sensor outputs that are detected using sensor outputs from the sensors 122 of the external device 104. The gesture command may be a non-contacting gesture command, in that it does not rely on contact of a body part of the user 108 (e.g., the user's hand) with a sensing device (e.g., a touchscreen sensor), but instead is a gesture that is captured by non-contacting sensors such as cameras. As an example, the gesture may be a hand motion that is performed by the user in the air in front of the wearable device 102. The gesture command may be a single gesture or a series of related gestures, which are referred to herein as sub-gestures. As used herein, a single gesture or a series of sub-gestures may be referred to collectively as a gesture. The information used to detect the gesture command may be or include images, three-dimensional scan data, or other sensor outputs.

Interpretation of the sensor outputs to identify the gesture may be performed by one or both of the controller 118 of the wearable device 102 and the controller 126 of the external device 104. In one implementation, the gesture is detected using a sensor output from at least one of the sensors 114 of the wearable device 102 or from at least one of the sensors 122 of the external device 104. In some implementations, the gesture is detected using a combined sensor output that includes information from at least one of the sensors 114 of the second display 120 and at least one of the sensors 122 that are associated with the external device 104. A combined sensor output may, for example, allow for more robust detection of gestures by capturing sensor information representing the gestures from multiple locations.

The gesture command may be a predetermined gesture command. The gesture command may be interpretable to identify the content item 230 that the user 108 intends to transfer from among multiple content items, and the gesture command may be interpretable to identify the external device 104 that the user 108 intends to transfer the content item 230 to from among multiple external devices. The gesture command may further be interpretable to determine a selection, by the user 108, of a position on the second display 120 of the external device 104 at which the content item 230 is to be displayed upon completion of the transfer.

In the implementations that are described herein, the gesture command is described as being a gesture made by the user 108 who is wearing the wearable device 102. In some implementations, the gesture may instead be performed by a third party (e.g., another person who is physically present with the user 108). In such implementations, the gesture command that is performed by the third party may be detected by the wearable device 102 or the external device 104, and may be acted on in the same manner as described with respect to a gesture command performed by the user 108. In some implementations, an authentication step may be performed. For example, one or both of the controller 118 of the wearable device 102 or the controller 126 of the external device 104 may be configured to determine that the gesture was made by a third party user, and determine whether the third party user is authorized by the user to request the transfer of the content item 230 (e.g., authorized to transfer the content item 230). This determination can be performed, for example, by accessing information that identifies authorized users and determining whether the third party user is identified as an authorized user by the information. In some implementations, the user 108 may be prompted to give permission, such as by a voice command that asks the user 108 whether the third party user may transfer the content item 230. In some implementations, the wearable device 102 notifies the user 108 of the transfer, such as by outputting a message on the first display 110 of the wearable device 102, by outputting an audible indication of the transfer, or by outputting a haptic indication of the transfer (e.g., vibration of a portion of the wearable device 102).

Operation 343, which is optional, includes requesting confirmation of the intention to transfer the display of the content item 230. Operation 343 may be included in the content transfer process 340 when the detection of intention in operation 342 represents an implicit intention or a predicted intention. As an example, operation 343 may include outputting a notification regarding the transfer and causing the transfer of display of the content item 230 (e.g., by proceeding to operation 344) upon receiving a confirmation input from the user in response to the notification. The notification may ask the user 108 whether to proceed with the transfer, and provide an opportunity to respond by confirming that the transfer should proceed (e.g., a confirmation input), or by cancelling the transfer (e.g., a cancellation input). The prompt may be output using the first display 110 of the wearable device 102, or may be presented to the user via another device, such as a smart phone or a smart watch that is carried by or worn by the user 108. Alternatively, the prompt may be an audible prompt that is output using an audio output component that is associated with the wearable device 102 or another device. The user 108 may respond by gesture command, by voice command, by operation of a physical button associated with the wearable device 102 or another device, or operation of a displayed touch sensitive button output by another device (e.g., smart phone or smart watch).

In operation 343, upon receipt of the confirmation input, the content transfer process 340 proceeds to operation 344. In some implementations, an indication of intention to transfer the content item 230 is output upon receiving the confirmation input, and this indication can be used to trigger performance of other operations. Upon receipt of the cancellation input, the content transfer process 340 ends. In implementation in which operation 343 is omitted, the content transfer process 340 proceeds directly to operation 344 from operation 342.

In operation 344, the display of the content item 230 is transferred from the first device to the second device in operation 344. In one example, in operation 344, display of the content item 230 by the first display 110 of the wearable device 102 stops, and display of the content item 230 by the second display 120 of the external device 104 starts.

The transfer of the display of content item 230 is facilitated by an exchange of information between the wearable device 102 and the external device 104 using the wireless communications connection established by the communications device 116 of the wearable device 102 and the communications device 124 of the external device 104. The type of information transferred from the wearable device 102 to the external device 104 varies dependent upon the manner in which the transfer is implemented. In one implementation, a command is sent from the wearable device 102 to the external device 104 that directs the external device 104 to display of the content item 230. The command may include information that identifies an application that is associated with display of the content item 230, and the command may include information that identifies an application state, for example, describing what the content item 230 is and/or how it was being displayed by the wearable device 102 so that the same display state can be replicated when display of the content item 230 starts on the external device 104.

In one implementation, the content item 230 is generated by execution of a computing process by the controller 118 of the wearable device 102, where the computing process is associated with display of the content item 230. Prior to the transfer, the computing process is responsible for presentation of the content item 230 at the first display 110 of the wearable device 102. Upon transfer display of the content item 230 to the second display 120 of the external device 104, the computing process continues to be executed by the controller 118 of the wearable device 102, with the content item 230 being streamed to the external device 104 from the wearable device 102.

In one implementation, the content item 230 is generated by execution of a first computing process by the controller 118 of the wearable device 102 prior to the transfer, where the computing process is associated with display of the content item 230 at the wearable device 102. After the transfer, the content item 230 is generated by execution of a second computing process by the controller 126 of the external device 104, and execution of the first computing process is terminated.

Prior to the transfer, the first computing process is responsible for presentation of the content item 230 at the first display 110 of the wearable device 102. Upon transfer display of the content item 230 to the second display 120 of the external device 104, the first computing process ends, and the second computing process is executed by the controller 126 of the external device 104, which causes display of the content item 230 at the second display 120. Thus, the controller 118 of the wearable device 102 and/or the controller 126 of the external device 104 may be configured to terminate execution of the first computing process associated with display of the content item 230 at the wearable device 102, and start execution of the second computing process associated with display of the content item 230 at the external device 104. In an alternative implementation the first computing process and the second computing process may both be executed after the transfer and together cause display of the content item 230 at the external device 104.

Display of the content item 230 at the wearable device 102 may end when the wearable device 102 instructs the external device 104 to start display of the content item 230. Alternatively, display of the content item 230 at the wearable device 102 may end when the wearable device 102 receives a transmission from the external device 104 indicating that display of the content item 230 has started at the external device 104. Alternatively, the wearable device 102 may determine that display of the content item 230 has started at the external device 104 using the sensors 114, and stop display of the content item 230 at the wearable device 102 in response. As an example, the wearable device 102 may obtain images using a camera from the sensors 114, and analyze the images (e.g., using machine vision techniques) to determine whether display of the content item 230 has started at the external device 104.

Once the transfer is completed, in operation 345, the content item 230 is displayed at the external device 104 using the second display 120.

It should be understood that the process 340 can be used to transfer the content item 230 from the external device 104 to the wearable device 102. As an example, a selection of the content item can be made in the same manner, such as by a verbal command that identifies the content item 230 while it is displayed by the external device 104 or by a gesture that is directed toward the content item 230 while it is displayed by the external device 104. Thus, the description made above, and the further examples herein are equally applicable to transfers from the external device 104 to the wearable device 102.

It should be understood that the process 340 can be initiated and/or controlled by the external device 104, such as by the controller 126 thereof. For example, outputs from the sensors 122 can be used by the controller 126 as inputs for judging intention to transfer the content item 230 in operation 342. As an example, the sensors 122 can be used to detect the location of the wearable device 102 (e.g., based on received signals and/or by analyzing images obtained by a camera), and thereby determine the wearable device 102 is at a location associated with the external device 104. As another example, the sensors 122 can be used to perceive gestures made by the user 108, which may be interpreted by the controller 126 in order to determine intention in operation 342. In such implementations, the controller 126 of the external device 104 can cause transfer of the content item 230 by wireless communication with the wearable device 102 to request the transfer.

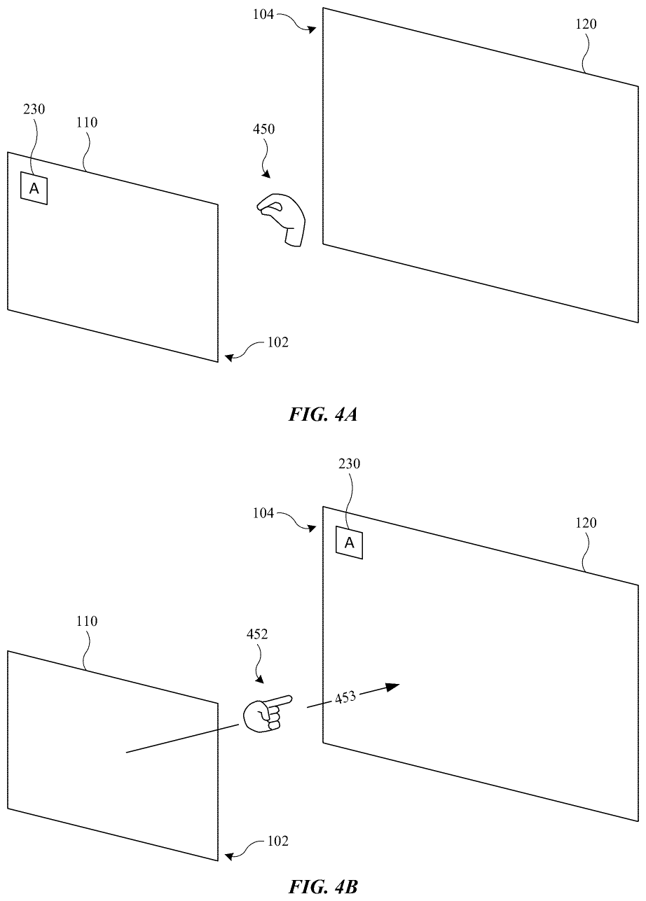

FIGS. 4A-4B are schematic illustrations that show content transfer using the system 100 according to a second example, in which a gesture command is interpreted as an expression of intention to transfer the content item 230, as described with respect to operation 342 of the content transfer process 340. In the illustrated implementation, the gesture command made by the user 108 (e.g., with one of their hands) includes a transfer initiation sub-gesture 450 and a transfer completion sub-gesture 452.

The transfer initiation sub-gesture 450 is interpreted as an indication, by the user 108, of intention to initiate transfer of the content item 230. The transfer initiation sub-gesture 450 is a predetermined gesture command, which may include any or all of a predetermined hand orientation, a predetermined hand position, a predetermined finger position (e.g., pinching, grasping, upturned flat hand and fingers, etc.), proximity to the wearable device 102, and contact with a portion of the wearable device 102.

The transfer initiation sub-gesture 450 may also function as a selection of the content item 230 from among multiple content items that are displayed by the wearable device 102 or the external device 104. As one example, the transfer initiation sub-gesture 450 may select the content item 230 by spatial correspondence of the transfer initiation sub-gesture 450 with a display location of the content item 230 on the first display 110 of the wearable device 102, as judged from the view point of the user 108. Determining this spatial correspondence may be performed using geometric methods based on the locations of the eyes of the user 108 and the transfer initiation sub-gesture 450 (e.g., the fingers of the user 108 making a pinch motion) and based on the display location of the content item 230 on the first display 110. In other words, the user 108 may make the transfer initiation sub-gesture 450 in a manner that appears, from the point of view of the user 108, to pinch the content item 230, which is interpreted as the user “picking up” the content item 230 with intention to transfer it to another device. This may be referred to as a transfer initiation gesture, a content selection gesture, or a “picking up” gesture.

Thus, to facilitate selection of the content item 230 for transfer from among multiple content items, one or more of the controller 118 of the wearable device 102 or the controller 126 of the external device 104 may be configured to determine a location of the external device 104 (e.g., based on sensor information), determine that the transfer initiation sub-gesture 450 indicates a selection of the content item 230 based on a spatial correspondence of the transfer initiation sub-gesture 450 with a display location of the content item 230 on the first display 110 of the wearable device 102, as judged from the view point of the user 108.

The transfer completion sub-gesture 452 functions to cause the transfer of the content item 230 to proceed, such as by causing performance of operation 344 and operation 345 of the content transfer process 340. The transfer completion sub-gesture 452 may also function to identify the external device 104 as the destination for the content item 230 (e.g., from among multiple possible destinations). As an example, motion of the transfer completion sub-gesture 452 may be used to identify the external device 104. This motion may be a movement of the transfer completion sub-gesture 452 (e.g., movement of the user's hand) toward the external device 104 (e.g., a “fling” motion) along a motion direction 453. This movement is performed subsequent to the transfer initiation sub-gesture 450 as part of the transfer completion sub-gesture 452 and can be referred to as a destination selection gesture or a “fling” gesture.

Thus, to facilitate selection of the external device 104 as the destination for the content item 230, one or more of the controller 118 of the wearable device 102 or the controller 126 of the external device 104 may be configured to determine a location of the external device 104 (e.g., based on sensor information), determine the motion direction 453 that is associated with the transfer completion sub-gesture 452, and determine that the transfer completion sub-gesture 452 indicates a selection of the external device 104 based on a comparison of the motion direction 453 to a location of the external device 104.

The transfer initiation sub-gesture 450 and the transfer completion sub-gesture 452, together, may be in the form of a “pinch and fling” gesture command by which the content item 230 is selected for transfer, the external device 104 is identified as the destination of the transfer, and by which completion of the combined gesture command causes the wearable device 102 and the external device 104 to perform the transfer of the content item 230. The “pinch and fling” gesture command is an example, and the transfer initiation sub-gesture 450 and the transfer completion sub-gesture 452 may take other forms.

In the implementation shown in FIGS. 4A-4B, the content item 230 may be positioned on the second display 120 of the external device 104 in any suitable way. As one example, the position of the content item 230 on the second display 120 of the external device 104 may be a predetermined position, such as a default position or a position that was previously selected by the user 108. As another example, the position of the content item 230 on the second display 120 of the external device 104 may be determined according to the position at which the content item 230 was displayed on the first display 110 of the wearable device 102 prior to the transfer.

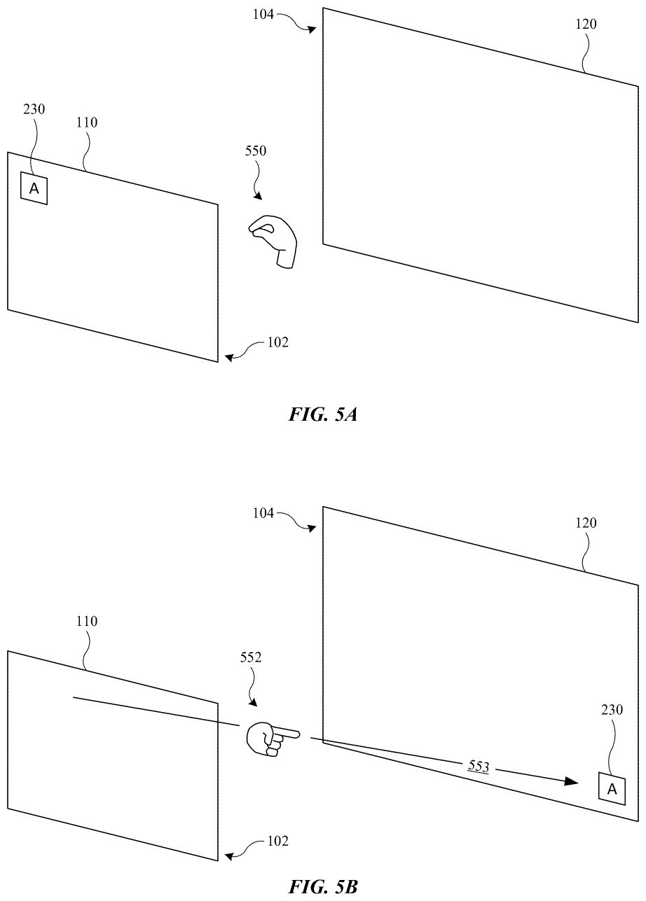

FIGS. 5A-5B are schematic illustrations that show content transfer using the system 100 according to a third example, in which the user makes a gesture command that is interpreted as an expression of intention to transfer the content item 230, as described with respect to operation 342 of the content transfer process 340. In the illustrated implementation, the gesture command includes a transfer initiation sub-gesture 550 and a transfer completion sub-gesture 552.

The transfer initiation sub-gesture 550 is interpreted as an indication, by the user 108, of intention to initiate transfer of the content item 230, and may also be a selection of the content item 230 from multiple content items. The transfer initiation sub-gesture 550 may be equivalent to the transfer initiation sub-gesture 450 and implemented in the same manner.

The transfer completion sub-gesture 552 may function as a selection of the external device 104 from among multiple devices and may also function as an indication that the transfer is to commence, and in these respects, the transfer completion sub-gesture 552 may be equivalent to the transfer completion sub-gesture 452 and implemented in the same manner. The transfer completion sub-gesture 452 may further function as a positioning input, made by the user 108, that specifies the position at which the content item 230 is to be displayed on the second display 120 of the external device 104. In particular, a motion direction 553 of the transfer completion sub-gesture 552 is used to determine the display position of the content item 230 on the second display 120 of the external device 104. As an example, geometric techniques can be used to estimate the location and angle of the motion direction 553 in three-dimensional space (e.g., based on sensor outputs) and by constructing an imaginary line in three-dimensional space, an intersection with the second display 120 of the external device 104 can be determined. The content item 230 can be positioned according to this intersection location, such as by placing the content item 230 at coordinates on the second display 120 that are based on the intersection location, or by selecting a predetermined display location on the second display 120 from among multiple discrete predetermined display locations (e.g., zones, quadrants, etc.).

Thus, to position the content item 230 on the second display 120 of the external device 104, one or more of the controller 118 of the wearable device 102 or the controller 126 of the external device 104 may be configured to determine a display location by determining the location of the external device 104, determining the motion direction 553 that is associated with the transfer completion sub-gesture 552, determining that the transfer completion sub-gesture 552 indicates a selection of the external device 104 based on a comparison of the motion direction 553 to the location of the external device 104, and determining the destination display position for the content item 230 based on the motion direction 553, wherein the transfer of the content item 230 between from the wearable device 102 to the external device 104 includes display of the content item 230 on the second display 120 of the external device 104 according to the destination display position.

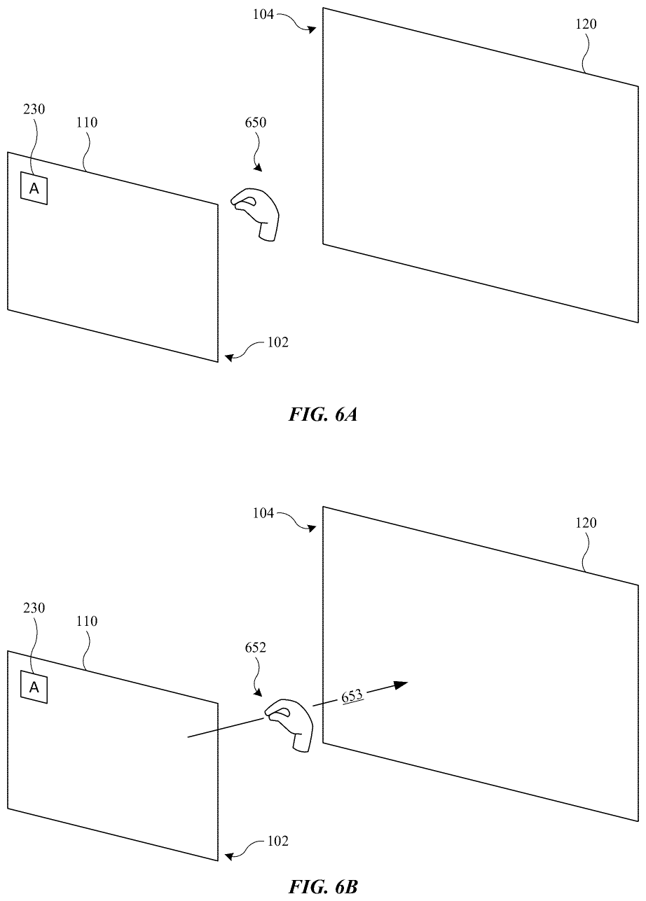

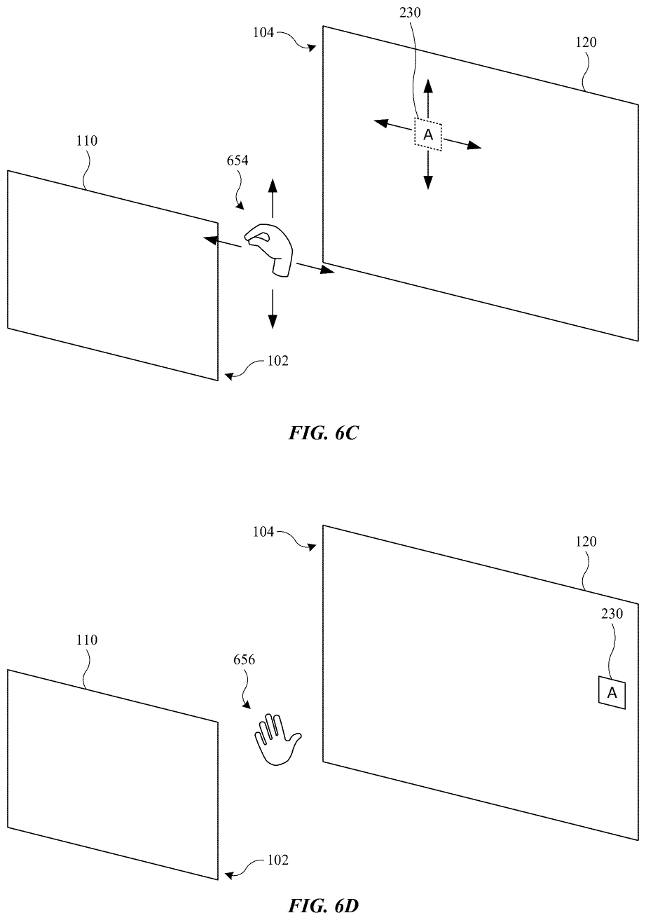

FIGS. 6A-6D are schematic illustrations that show content transfer using the system 100 according to a fourth example, in which the user makes a gesture command that is interpreted as an expression of intention to transfer the content item 230, as described with respect to operation 342 of the content transfer process 340. In the illustrated implementation, the gesture command includes a transfer initiation sub-gesture 650 and a destination selection sub-gesture 652, a positioning sub-gesture 654, and a transfer completion sub-gesture 656.

The transfer initiation sub-gesture 650 is interpreted as an indication, by the user 108, of intention to initiate transfer of the content item 230, and may also be a selection of the content item 230 from multiple content items. The transfer initiation sub-gesture 650 may be equivalent to the transfer initiation sub-gesture 450 and implemented in the same manner.

The destination selection sub-gesture 652 functions as a selection of the external device 104 from among multiple devices and may be implemented in the manner described with respect to selection of the external device 104 as part of the transfer completion sub-gesture 452 and the transfer completion sub-gesture 552. As an example, the destination selection sub-gesture 652 can be used to determine that the external device 104 is the intended destination for the transfer according to a motion direction 653 of the destination selection sub-gesture 652, by comparing the motion direction 653 to the location of the external device 104, as previously described with respect to the motion direction 553.

After the external device 104 is identified as the destination for the transfer, and prior to the transfer completion sub-gesture 656, the positioning sub-gesture 654 may be used to select a position of the content item 230 on the second display 120 of the external device 104 according to motion of the sub-gesture 654. For example, the content item 230 may be displayed on the second display 120 of the external device 104 at a preliminary location. A graphical display of the content item 230 may be configured to indicate that the position of the content item 230 is not final, such as by displaying an icon with the content item 230 or applying a graphical effect such as transparency or glowing to the content item 230. During performance of the sub-gesture 654, the location of the content item 230 on the second display 120 may be changed in accordance with movement of the sub-gesture 654. For example, movement of the sub-gesture 654 in a plane that is generally parallel to the plane of the second display 120 of the external device 104 can be tracked and used to move the position of the content item 230 on the second display 120 in a corresponding manner.

The transfer completion sub-gesture 656 functions as an indication that the transfer is to commence, and in these respects, the transfer completion sub-gesture 552 may be equivalent to the transfer completion sub-gesture 452 and implemented in the same manner. The position of the content item 230 at the time of performance of the transfer completion sub-gesture 656, as set by the positioning sub-gesture 654, is used to set the display position of the content item 230, such as by placing the content item 230 at the location specified in the sub-gesture 654 or snapping the location of the content item 230 to a predetermined location (e.g., on a grid or selected from among multiple discrete locations).

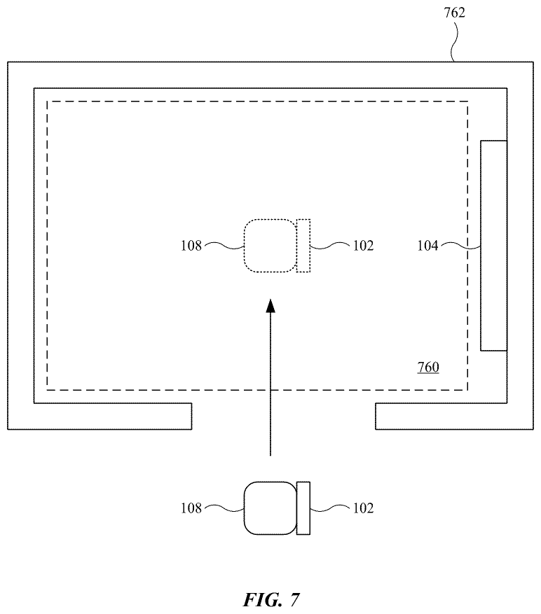

FIG. 7 is schematic illustration of content transfer using the system 100 according to a fifth example, in which presence of the wearable device 102 at a particular location is interpreted as an expression of intention to transfer the content item 230, as described with respect to operation 342 of the content transfer process 340. In the illustrated example, the user 108 is wearing the wearable device 102 and moves from a location that is outside of a predefined area 760 (this position of the user 108 and the wearable device 102 is represented by solid lines) to a location that is inside the predefined area 760 (this position of the user 108 and the wearable device 102 is represented by dashed lines). In response to movement of the wearable device 102 into the predefined area 760, presence of the wearable device 102 in the predefined area 760 is interpreted as an expression of intent to transfer the content item 230 to the external device 104, which is located in or near the predefined area 760, and the transfer proceeds in the manner described with respect to the content transfer process 340. The transfer may be performed automatically in response to entry in to the predefined area 760, or confirmation of the transfer may be requested before proceeding, as described with respect to operation 343.

As one example, the predefined area 760 can be set manually as a boundary that includes locations within which transfer to the external device 104 is desired. As another example, the room 762 can be set to the extents of a defined space, such as a room. As another example, the predefined area 760 may be set according to a threshold distance around the external device 104.

In the illustrated example, the predefined area 760 is within a room 762, and the transfer occurs automatically or upon confirmation from the user 108 in response to the user 108 and the wearable device 102 entering the room 762. In a related example, the predefined area 760 is a passenger cabin of an automobile, and the transfer occurs automatically or upon confirmation from the user 108 in response to the user 108 and the wearable device 102 entering the passenger cabin. In this example, the external device 104 may be an infotainment system or heads up display of the automobile. In an alternative example, the predefined area corresponds to the user 108 sitting in a chair, and the transfer occurs automatically or upon confirmation from the user 108 in response to the user 108 having sat in the chair. In this example, the chair may be a seat in an aircraft cabin, and the external device 104 may be an entertainment device that is associated with the seat. In a related example, the predefined area 760 corresponds to the user 108 sitting in a seat in an automobile, and the transfer occurs automatically or upon confirmation from the user 108 in response to the user 108 sitting in the seat. In this example, the external device 104 may be an infotainment system or heads up display of the automobile.

Thus, the controller 118 of the wearable device 102 may be configured to display the content item 230 to the user of the wearable device 102, to determine that the wearable device 102 is in a location that is associated with the external device 104, such as the predefined area 760, and to transfer display of the content item 230 from the wearable device 102 to the external device 104 in response to the determination that the wearable device 192 is in the location that is associated with the external device 104. The controller 118 of the wearable device 102 may be further configured to transfer display of the content item 230 by outputting a notification regarding transfer of display of the content item 230 and causing transfer of display of the content item 230 upon receiving a confirmation input from the user 108 in response to the notification. The controller 118 of the wearable device 102 may be further configured to transfer display of the content item 230 by automatically causing transfer of display of the content item 230 in response to the determination that the wearable device 104 is in the location that is associated with the external device 104.

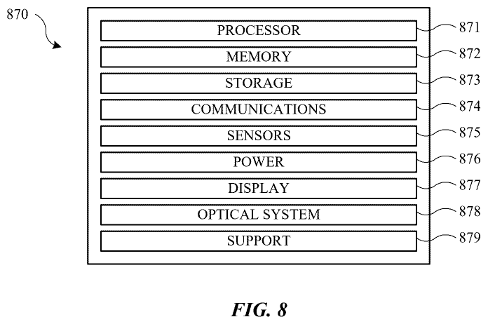

FIG. 8 is a block diagram that shows an example of a hardware configuration for a device 870 that can be used to implement devices that are included in the system, such as the wearable device 102 and the external device 104. Devices that are included in the system 100 may include some or all of the components described in connection with the system 100. Some devices that are included in the system 100 may omit certain components of the device 870, such as components that are specific to wearable devices and/or CGR devices. In the illustrated example, the electronic device includes a processor 871, a memory 872, a storage device 873, a communications device 874, sensors 875, a power source 876, a display device 877, an optical system 878, and a support 879.

The processor 871 is a device that is operable to execute computer program instructions and is operable to perform operations that are described by the computer program instructions. The processor 871 may be implemented using one or more conventional devices and/or more or more special-purpose devices. The memory 872 may be one or more volatile, high-speed, short-term information storage devices such as random-access memory modules. The storage device 873 is intended to allow for long term storage of computer program instructions and other data. Examples of suitable devices for use as the storage device 873 include non-volatile information storage devices of various types, such as a flash memory module, a hard drive, or a solid-state drive.

The communications device 874 supports wired or wireless communications with other devices. Any suitable wired or wireless communications protocol may be used.

The sensors 875 are components that are incorporated in the device 870 to generate sensor output signals. The sensor outputs may be used as inputs by the processor 871 for use in generating content, such as CGR content. The sensors 875 may include components that facilitate motion tracking. The sensors 875 may include conventional components such as cameras, infrared cameras, infrared emitters, depth cameras, structured-light sensing devices, accelerometers, gyroscopes, and magnetometers. The information that is generated by the sensors 875 is provided to other components of the device 870, such as the processor 871, as inputs.

The power source 876 supplies electrical power to components of the device 870. In some implementations, the power source 876 is a wired connection to electrical power. In some implementations, the power source 876 may include a battery of any suitable type, such as a rechargeable battery.

The display device 877 functions to display content to the user in the form of emitted light that is output by the display device 877 and is directed toward the user's eyes by the optical system 878. The display device 877 is a light-emitting display device, such as a video display of any suitable type, that is able to output images in response to a signal that is received from the processor 871. The display device 877 may be of the type that selectively illuminates individual display elements according to a color and intensity in accordance with pixel values from an image. As examples, the display device 877 may be implemented using a liquid-crystal display (LCD) device, a light-emitting diode (LED) display device, a liquid crystal on silicon (LCoS) display device, an organic light-emitting diode (OLED) display device, or any other suitable type of display device. The display device 877 may include multiple individual display devices.

The optical system 878 can be utilized to output CGR content to the user 108. In devices that do not present CGR content, the optical system 878 is omitted. The optical system 878 may include lenses, reflectors, polarizers, filters, optical combiners, and/or other optical components. The support 879 can be utilized to allow the device 870 to be worn, and is omitted in devices that are not wearable. The support may include a strap, a headband, a facial interface, and/or other structures that are configured to support the device 870 relative to the body of the user 108.

A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

In contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands).

A person may sense and/or interact with a CGR object using any one of their senses, including sight, sound, touch, taste, and smell. For example, a person may sense and/or interact with audio objects that create three-dimensional or spatial audio environment that provides the perception of point audio sources in three-dimensional space. In another example, audio objects may enable audio transparency, which selectively incorporates ambient sounds from the physical environment with or without computer-generated audio. In some CGR environments, a person may sense and/or interact only with audio objects.

Examples of CGR include virtual reality and mixed reality.

A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end.

In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

Examples of mixed realities include augmented reality and augmented virtuality.

An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment.

An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

There are many different types of electronic systems that enable a person to sense and/or interact with various CGR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

As described above, one aspect of the present technology is the gathering and use of data available from various sources for use during operation of devices and applications. As an example, such data may identify the user and include user-specific settings or preferences. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, a user profile may be established that stores authorization related information that allows a device to identify other devices that content can be transferred to. Accordingly, use of such personal information data enhances the user's experience.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of storing a user profile for facilitating content sharing, the present technology can be configured to allow users to select to “opt in” or “opt out” of participation in the collection of personal information data during registration for services or anytime thereafter. In another example, users can select not to provide data regarding usage of specific applications. In yet another example, users can select to limit the length of time that application usage data is maintained or entirely prohibit the development of an application usage profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, preferences may be determined each time the device is used, such as by prompting the user to supply the needed information, and without subsequently storing the information or associating the information with the particular user.

What is claimed is:

1. A wearable device, comprising:
a display device configured to present first content in combination with a view of an environment; and
a controller is configured to:
detect an intention to transfer display of a content item between the display device and an external device configured to present second content, and
transfer display of the content item in response to detection of the intention.

2. The wearable device of claim 1, wherein the controller is further configured to:
detect a gesture, wherein the intention to transfer display of the content item is detected based on the gesture.

3. The wearable device of claim 2, wherein the controller is further configured to:
determine that the gesture indicates a selection of the external device based on a comparison of a view angle of the wearable device to a location of the external device.

4. The wearable device of claim 2, wherein the controller is further configured to:
determine a motion direction associated with the gesture, and
determine that the gesture indicates a selection of the external device based on a comparison of the motion direction to a location of the external device.

5. The wearable device of claim 2, wherein the controller is further configured to:
determine a motion direction associated with the gesture, and
determine a destination display position for the content item based on the motion direction, wherein the controller transfers display of the content item according to the destination display position.

6. The wearable device of claim 2, wherein the gesture includes a transfer initiation sub-gesture, a positioning sub-gesture, and a transfer completion sub-gesture, and the controller is further configured to determine a destination display position for the content item on at least one of the wearable device or the external device based on the positioning sub-gesture.

7. The wearable device of claim 1, wherein the intention to transfer display of the content item is detected based on a determination that the wearable device is at a location associated with the external device.

8. The wearable device of claim 1, wherein the intention to transfer display of the content item is detected based on a determination that a view angle of the wearable device corresponds to a location of the external device.

9. A device, comprising:
a display device configured to present first content to a user; and
a controller configured to:
detect an intention to transfer display of a content item between the display device and a wearable device configured to present second content to the user in combination with a view of an environment, and
transfer display of the content item in response to detection of the intention.

10. The device of claim 9, wherein the controller is further configured to:
detect a gesture, wherein the intention to transfer display of the content item is detected based on the gesture.

11. The device of claim 10, wherein the controller is further configured to:
determine that the gesture indicates a selection of the device based on a comparison of a view angle of the wearable device to a location of the device.

12. The device of claim 10, wherein the controller is further configured to:
determine a motion direction associated with the gesture, and
determine that the gesture indicates a selection of the device based on a comparison of the motion direction to a location of the device.

13. The device of claim 10, wherein the controller is further configured to:
determine a motion direction associated with the gesture, and
determine a destination display position for the content item based on the motion direction, wherein the controller transfers display of the content item according to the destination display position.

14. The device of claim 10, wherein the gesture includes a transfer initiation sub-gesture, a positioning sub-gesture, and a transfer completion sub-gesture, and the controller is further configured to determine a destination display position for the content item on at least one of the wearable device or the device based on the positioning sub-gesture.

15. The device of claim 9, wherein the intention to transfer display of the content item is detected based on a determination that the wearable device is at a location associated with the device.

16. The device of claim 9, wherein the intention to transfer display of the content item is detected based on a determination that a view angle of the wearable device corresponds to a location of the device.

17. A system, comprising:
a wearable device configured to present first content to a user in combination with a view of an environment;
an external device configured to present second content to the user; and
a controller associated with at least one of the wearable device or the external device, wherein the controller is configured to:
detect an intention to transfer display of a content item between the wearable device and the external device, and
transfer display of the content item in response to detection of the intention.

18. The system of claim 17, wherein the controller is further configured to:
detect a gesture, wherein the intention to transfer display of the content item is detected based on the gesture,
determine a motion direction associated with the gesture,
determine that the gesture indicates a selection of the external device based on a comparison of the motion direction to a location of the external device, and
determine a destination display position for the content item based on the motion direction, wherein the controller transfers display of the content item according to the destination display position.

19. The system of claim 17, wherein the intention to transfer display of the content item is detected based on a determination that the wearable device is at a location associated with the external device.

20. The system of claim 17, wherein the intention to transfer display of the content item is detected based on a determination that a view angle of the wearable device corresponds to a location of the external device.
